(19) United States
(12) Patent Application Publication
(10) Pub. No.: US 2003/0191644 A1
(43) Pub. Date: Oct. 9, 2003

(54) Vocalizing input device for computer facilities

(76) Inventor: Wen Hao Chang, Taichung (TW)

Correspondence Address: Wen Hao CHANG, P.O. Box 63-99, Taichung, 406, TW

(21) Appl. No.: 10/118,558

(22) Filed: Apr. 4, 2002

(51) Int. Cl. G10L 13/00

(52) U.S. Cl. 704/258

(57) ABSTRACT

A vocalizing input device includes a processor device for coupling to various computer facilities, one or more input devices for entering sounds and voices into the processor device, one or more devices for entering information corresponding to the sounds and voices into the processor device, and one or more memories for storing the sounds and voices and the information corresponding to the sounds and voices. The processor device may compare the newly entered and the stored sounds and voices, and then may provide the corresponding information to the computer facilities.

### BACKGROUND OF THE INVENTION

1. Field of the Invention

The present invention relates to a vocalizing input device, and more particularly to a vocalizing input device for computer facilities.

2. Description of the Prior Art

Typical computer facilities comprise a number of input devices, such as the mice, the keyboards, the photo sensors, etc. Recently, vocalizing input devices have been developed for allowing the information to be entered into the computer facilities with sounds or voices, without the other input devices, such as the mice, the keyboards, the photo sensors, etc. However, the voices and sounds are different from people to people, such that the vocalizing input devices may not be widely used for data inputting purposes.

In addition, the languages are different from countries to countries, or from areas to areas. This is another reason why the vocalizing input devices still may not be widely used for data inputting purposes. Furthermore, the notebooks or the other compact processors or compact computer facilities, and the mobile phones or the portable phones may not be coupled with mice, keyboards, or photo sensors, such that the information also may not be easily entered into the computer facilities.

The present invention has arisen to mitigate and/or obviate the afore-described disadvantages of the conventional vocalizing input devices for computer facilities.

### SUMMARY OF THE INVENTION

The primary objective of the present invention is to provide a vocalizing input device for allowing the users to enter information into the computer facilities and/or the notebooks or the other compact processors or compact computer facilities, and/or the mobile phones or the portable phones, without the other input devices, such as the mice, the keyboards, the photo sensors, etc.

In accordance with one aspect of the invention, there is provided a vocalizing input device for computer facilities, the vocalizing input device comprising a processor device for coupling to various computer facilities, and at least one memory coupled to the processor device for storing the sounds and voices and the information corresponding to the sounds and voices. The processor device may be provided for comparing newly entered sounds and voices with the sounds and voices stored in the memory, and for providing the corresponding information to the computer facilities.

The sounds and the voices of the user may be entered into the processor device with such as the microphones, and the information corresponding to the sounds and voices may further be entered into the processor device, with the other input facilities, such as the mice, the keyboards, the photo sensors, etc., for allowing the processor device to recognize or to distinguish or to know what the person has spoken. The information of the voices or sounds of the person, and the corresponding words or characters or letters of the voices or sounds may also be stored in the memory for further use. The sounds and the voices of the users may thus be recognized by the processor device, and may then be supplied or entered into the computer facilities.

A casing may further be provided for receiving the memory and the processor device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view illustrating a vocalizing input device for computer facilities in accordance with the present invention;

FIGS. 2, 3, 4 are perspective views illustrating the other applications or operations of the vocalizing input device for computer facilities; and

FIG. 5 is a flow chart illustrating the operation of the vocalizing input device for computer facilities.

### DETAILED DESCRIPTION OF THE PREFERRED EMBODIMENT

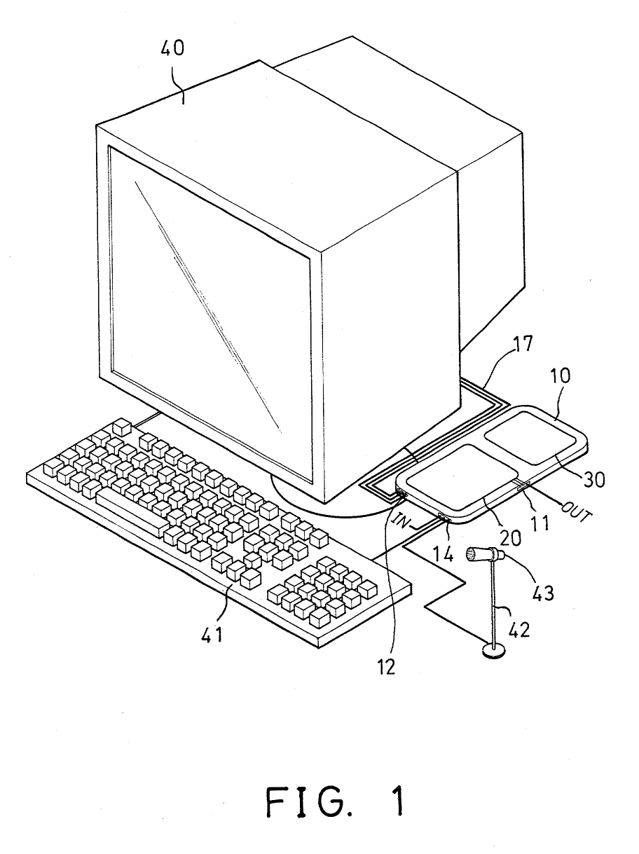

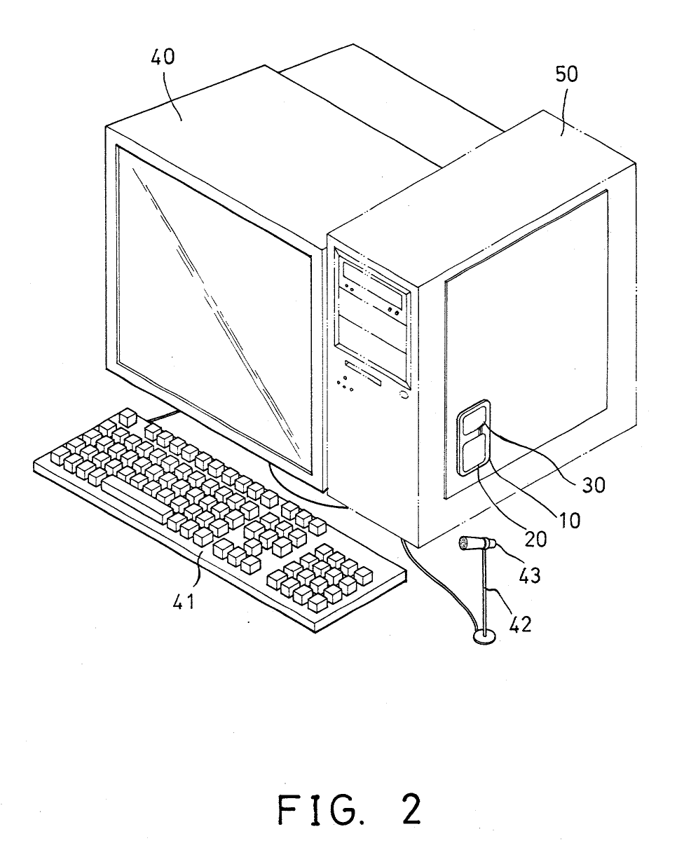

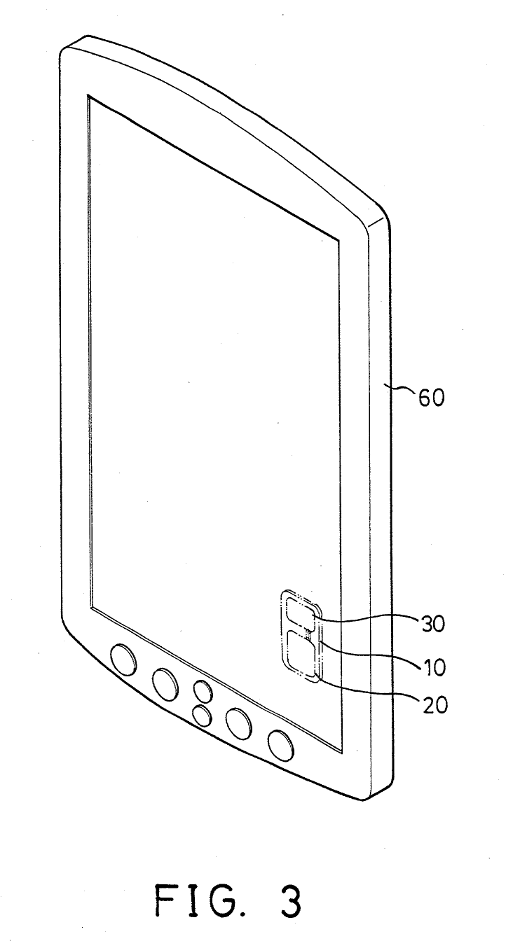

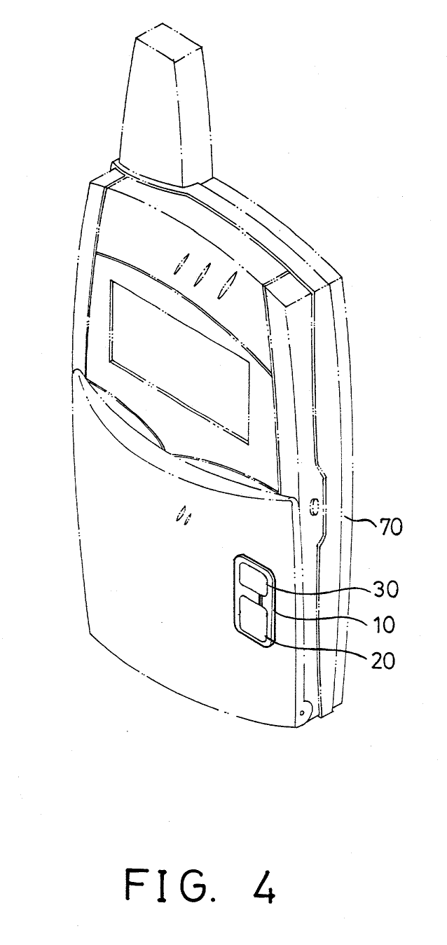

Referring to the drawings, and initially to FIG. 1, a vocalizing input device for computer facilities in accordance with the present invention comprises a casing 10 including a processor device 20, one or more memories 30 disposed therein and coupled to the processor device, and including an output port 11 for coupling to the computer facilities 50 (FIG. 2), or to the notebooks or the other compact processors or compact computer facilities 60 (FIG. 3), or the mobile phones or the portable phones 70 (FIG. 4).

The casing 10 may include another outlet port 12 for coupling to the displayer devices 40, such as the monitors 40, with such as the wires or cables 17, for information displaying purposes. The casing 10 may further include an inlet port 14 for coupling the keyboards 41 and/or the microphones 43 thereto. The microphones 43 may be supported on the required positions or height with the supports or stands 42.

Referring next to FIGS. 2-4, the casing 10 of the vocalizing input device may also be built-in, or plugged into, or coupled to the sockets or the couplers of the computer facilities 50 (FIG. 2), or to the notebooks or the other compact processors or compact computer facilities 60 (FIG. 3), or the mobile phones or the portable phones 70 (FIG. 4), for allowing the users to enter information into the computer facilities 50, or the notebooks or the other compact processors or compact computer facilities 60, or the mobile phones or the portable phones 70, without the other input devices, such as the mice, the keyboards, the photo sensors, etc.

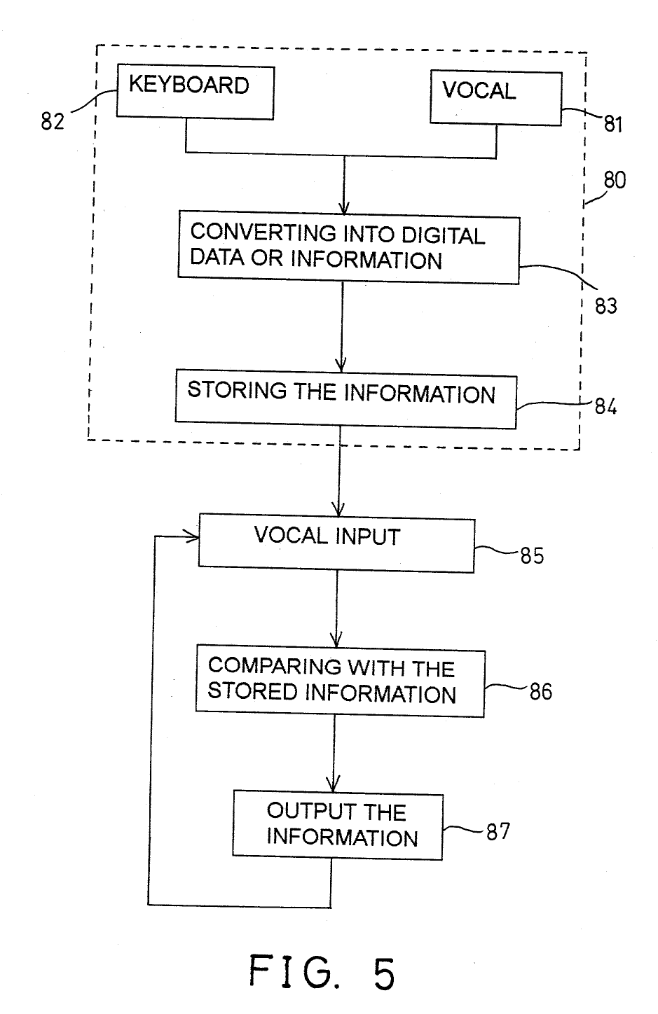

Referring next to FIG. 5, illustrated are the processes for operating the vocalizing input device for computer facilities. In operation, the user may enter his voices or sounds into the processor device 20 with the microphone 43, for example, at the process 81, and may enter the corresponding words or characters or letters of the voices or sounds into the processor device 20 with the keyboard 41, at the process 82. The processor device 20 may then treat or process the voices or sounds, or may convert the voices or sounds into digital data at the process 83. The digital data may then be stored in the memory 30 at the process 84.

The processes 81-84 enclosed or surrounded by a dotted boundary line 80 may be provided for entering the voices or sounds of a predetermined or particular person into the processor device 20, and for entering the corresponding words or characters or letters of the voices or sounds into the processor device 20 with the keyboard 41, for allowing the processor device 20 to recognize or to distinguish or to know what the person has spoken. The information of the voices or sounds of the person, and the corresponding words or characters or letters of the voices or sounds may then be stored in the memory 30 for further use.

After the information of the voices or sounds of the person, and the corresponding words or characters or letters of the voices or sounds have been stored in the memory 30, the user may then enter any sounds or voices into the computer facilities 50, or the notebooks or the other compact processors or compact computer facilities 60, or the mobile phones or the portable phones 70, at the process 85. The processor device 20 may then compare the entered voices or sounds with the stored information in the memory 30 at the process 86, and may then output the corresponding words or characters or letters of the voices or sounds, in such as the displayer devices or the monitors 41 (FIGS. 1, 2), or in the displayer devices of notebooks or the other compact processors or compact computer facilities 60, or the mobile phones or the portable phones 70, at the process 87.

It is to be noted that the voices or sounds and the corresponding words or characters or letters of the voices or sounds of the particular person or persons may be stored or memorized in the memory 30, and may be compared with the newly entered sounds or voices, such that the sounds or the voices of the particular person or persons may be suitably recognized or distinguished by the vocalizing input device, such that the information may be easily entered into the computer facilities 41, 50 as shown in FIGS. 1 and 2, or the notebooks or the other compact processors or compact computer facilities 60, or the mobile phones or the portable phones 70 by the particular persons, without the other input devices, such as the mice, the keyboards, the photo sensors, etc.

Accordingly, the vocalizing input device in accordance with the present invention may be provided for allowing the users to enter information into the computer facilities and/or the notebooks or the other compact processors or compact computer facilities, and/or the mobile phones or the portable phones, without the other input devices, such as the mice, the keyboards, the photo sensors, etc.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vocalizing input device for computer facilities, said vocalizing input device comprising:
a processor device for coupling to various computer facilities,
at least one memory coupled to said processor device for storing sounds and voices and information corresponding to the sounds and voices,
said processor device being provided for comparing newly entered sounds and voices with the sounds and voices stored in said at least one memory, and for providing the corresponding information to the computer facilities.

2. The vocalizing input device according to claim 1 further comprising a casing for receiving said at least one memory and said processor device.

3. A vocalizing input device for computer facilities, said vocalizing input device comprising:
a processor device for coupling to various computer facilities,
means for entering sounds and voices into said processor device,
means for entering information corresponding to the sounds and voices into said processor device, and
at least one memory coupled to said processor device for storing the sounds and voices and the information corresponding to the sounds and voices,
said processor device being provided for comparing newly entered sounds and voices with the sounds and voices stored in said at least one memory, and for providing the corresponding information to the computer facilities.

4. The vocalizing input device according to claim 3 further comprising a casing for receiving said at least one memory and said processor device.
